(19) United States
(12) Patent Application Publication
(10) Pub. No.: US 2019/0140744 A1
(43) Pub. Date: May 9, 2019

(54) SPLIT TERRESTRIAL BACKHAUL SYSTEMS AND METHODS FOR SUBSEA OPTICAL COMMUNICATION LINKS

(71) Applicant: Facebook, Inc., Menlo Park, CA (US)

(72) Inventors: Nitin Kumar Goel, Mountain View, CA (US); Herve Albert Pierre Fevrier, Redwood City, CA (US); Gayathrinath Nagarajan, Saratoga, CA (US)

(21) Appl. No.: 15/805,990

(22) Filed: Nov. 7, 2017

(51) Int. Cl. H04B 10/80

(52) U.S. Cl. CPC H04B 10/80

(57) ABSTRACT

The disclosed method may include, at a cable landing site for a subsea optical fiber, (1) receiving a plurality of optical signals carried over the subsea optical fiber, the plurality of optical signals including a first set of optical signals in a first wavelength band and at least one additional set of optical signals in at least one additional wavelength band that is different from the first wavelength band, (2) optically splitting the plurality of optical signals into the first set of optical signals and the additional set of optical signals, (3) introducing, after optically splitting the plurality of optical signals, the first set of optical signals onto a first terrestrial optical fiber, and (4) introducing, after optically splitting the plurality of optical signals, the additional set of optical signals onto at least one additional terrestrial optical fiber different from the first terrestrial optical fiber. Various other methods and systems are also disclosed.

### BACKGROUND

Subsea communication cables have long facilitated communications between continents. To facilitate greater communication bandwidth, modern subsea communication cables typically employ optical communication technology by including a number of optical fibers, each of which may carry multiple optical communication signals using dense wavelength-division multiplexing (DWDM) technology. The cable may also include electrical conductors that supply power to intermediate optical amplifiers located at various points along the cable.

Generally, subsea communication cables are expensive to lay and maintain. Additionally, the number of optical fibers present in a “repeatered” subsea cable (e.g., a subsea optical cable with intermediate optical amplifiers) are typically restricted to 16-24 fibers to limit the size and weight of the cable. Consequently, subsea communication operators typically want to maximize communication capacity for each optical fiber of a cable. To that end, some such systems employ DWDM signals in both the C and L optical bands in each fiber to carry communication signals. The C optical band normally occupies the wavelength range of 1530 to 1565 nanometers (nm), typically resulting in about 96 communication channels, each of which may support a data rate of approximately 100 gigabits per second (Gbits/s) per channel. The L optical band, in many cases, covers the wavelength range of 1565-1625 nm, facilitating about twice the number of communication channels, also at 100 Gbits/s per channel. In newer subsea cables with updated transponder modulation schemes, up to 200 Gbits/s per channel may be attained.

Terrestrial optical communication cables, on the other hand, typically carry hundreds (e.g., 500-600) optical fibers, as laying and maintaining such cables is generally not as expensive or difficult to lay (e.g., bury) or maintain. However, terrestrial cables are traditionally more prone to accidental fiber cuts or other failures due to proximity with human or other animal activity (e.g., human excavation activities for tunnels, pipes, or other construction projects). Consequently, a failure of an entire terrestrial optical cable may result in the loss of many more communication channels compared to a subsea cable failure.

### SUMMARY

As will be described in greater detail below, the instant disclosure describes split terrestrial backhaul systems and methods for subsea optical communication links. In one example, a method for a split terrestrial backhaul system may include (1) receiving, at a cable landing site for a subsea optical fiber, a plurality of optical signals carried over the subsea optical fiber, the plurality of optical signals including a first set of optical signals in a first wavelength band and at least one additional set of optical signals in at least one additional wavelength band that is different from the first wavelength band, (2) optically splitting, at the cable landing site, the plurality of optical signals into the first set of optical signals and the at least one additional set of optical signals, (3) introducing, at the cable landing site after optically split he plurality of optical signals, the first set of optical signals onto a first terrestrial optical fiber, and (4) introducing, at the cable landing site after optically splitting the plurality of optical signals, the at least one additional set of optical signals onto at least one additional terrestrial optical fiber that is different from the first terrestrial optical fiber.

In some example embodiments, the first wavelength band may include a C optical wavelength band, and the at least one additional wavelength band may include an L optical wavelength band.

In some examples, the method may further include optically amplifying the plurality of optical signals before optically splitting the plurality of optical signals.

In example embodiments, the method may further include (1) optically amplifying the first set of optical signals after optically splitting the plurality of optical signals, and (2) optically amplifying the at least one additional set of optical signals after optically splitting the plurality of optical signals.

In some examples, the method may also include (1) carrying, by the first terrestrial optical fiber, the first set of optical signals from the cable landing site to a network point of presence, and (2) carrying, by the at least one additional terrestrial optical fiber, the at least one additional set of optical signals from the cable landing site to the network point of presence. In an example embodiment, the first terrestrial optical fiber may follow a first path and the at least one additional terrestrial optical fiber may follow at least one additional path that is different from the first path.

In some embodiments, the method may further include (1) carrying, by the first terrestrial optical fiber, the first set of optical signals from the cable landing site to a first network point of presence, and (2) carrying, by the at least one additional terrestrial optical fiber, the at least one additional set of optical signals from the cable landing site to at least one additional network point of presence that is different from the first network point of presence.

In addition, another split terrestrial backhaul method for subsea optical communication links may include (1) receiving, at a cable landing site for a subsea optical fiber, a first set of optical signals carried over a first terrestrial optical fiber in a first wavelength band, (2) receiving, at the cable landing site, at least one additional set of optical signals carried over at least one additional terrestrial optical fiber in at least one additional wavelength band that is different from the first wavelength band, (3) optically combining, at the cable landing site, the first set of optical signals and the at least one additional set of optical signals to form a plurality of optical signals, and (4) introducing, at the cable landing site after optically combining the first set of optical signals and the at least one additional set of optical signals, the plurality of optical signals onto the subsea optical fiber.

In some examples, the first wavelength band may include a C optical wavelength band, and the at least one additional wavelength band may include an L optical wavelength band.

In some embodiments, the method may further include optically amplifying the plurality of optical signals after optically combining the first set of optical signals and the at least one additional set of optical signals.

In an example, the method may further include (1) optically amplifying the first set of optical signals before optically combining the first set of optical signals and the at least one additional set of optical signals, and (2) optically amplifying the at least one additional set of optical signals before optically combining the first set of optical signals and the at least one additional set of optical signals.

In some embodiments, the method may further include (1) carrying, by the first terrestrial optical fiber, the first set of optical signals from a network point of presence to the cable landing site, and (2) carrying, by the at least one additional terrestrial optical fiber, the at least one additional set of optical signals from the network point of presence to the cable landing site. In some examples, the first terrestrial optical fiber follows a first path and the at least one additional terrestrial optical fiber follows at least one additional path that is different from the first path.

In some examples, the method may also include, (1) carrying, by the first terrestrial optical fiber, the first set of optical signals from a first network point of presence to the cable landing site, and (2) carrying, by the at least one additional terrestrial optical fiber, the at least one additional set of optical signals from at least one additional network point of presence that is different from the first network point of presence to the cable landing site.

Moreover, a corresponding split terrestrial backhaul system for subsea optical communication links may include (1) an optical signal splitter, located at a cable landing site, that may optically split a first plurality of optical signals received from a first subsea optical fiber into a first set of optical signals in a first wavelength band for introduction onto a first terrestrial optical fiber, and a second set of optical signals in a second wavelength band different from the first wavelength band for introduction onto a second terrestrial optical fiber different from the first terrestrial optical fiber, and (2) an optical signal combiner, located at the cable landing site, that may optically combine a third set of optical signals in the first wavelength band received from a third terrestrial optical fiber and a fourth set of optical signals in the second wavelength band received from a fourth terrestrial optical fiber to form a second plurality of optical signals for introduction onto a second subsea optical fiber.

In some examples, the second subsea optical fiber may be the first subsea optical fiber. Also in some examples, the third terrestrial optical fiber may be the first terrestrial optical fiber, and/or the fourth terrestrial optical fiber may be the second terrestrial optical fiber.

In some example embodiments, the first terrestrial optical fiber and the third terrestrial optical fiber may couple the cable landing site to a network point of presence along a first path, and the second terrestrial optical fiber and the fourth terrestrial optical fiber may couple the cable landing site to the network point of presence along a second path different from the first path.

In some embodiments, the first terrestrial optical fiber and the third terrestrial optical fiber may couple the cable landing site to a first network point of presence along a first path, and the second terrestrial optical fiber and the fourth terrestrial optical fiber may couple the cable landing site to a second network point of presence different from the first network point of presence along a second path different from the first path.

Features from any of the above-mentioned embodiments may be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The accompanying drawings illustrate a number of exemplary embodiments and are a part of the specification. Together with the following description, these drawings demonstrate and explain various principles of the instant disclosure.

FIG. 1 is a flow diagram of an example split backhaul method for subsea optical communication links.

FIG. 2 is a flow diagram of another example split backhaul method for subsea optical communication links.

FIG. 3 is a block diagram of an example split backhaul system for subsea optical communication links involving a single point of presence (POP) coupled to each cable landing site of a subsea optical communication link.

FIG. 4 is a block diagram of an example split backhaul system for subsea optical communication links involving two POPs coupled to each cable landing site of a subsea optical communication link.

FIGS. 5-8 are block diagrams an example cable landing site employable in the example split backhaul systems of FIGS. 3 and 4.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION OF EXEMPLARY EMBODIMENTS

The present disclosure s generally directed to split backhaul systems and methods for subsea optical communication links. As will be explained in greater detail below, embodiments of the instant disclosure may include, for a cable landing site for a subsea optical fiber, (1) receiving a plurality of optical signals carried over the subsea optical fiber, the plurality of optical signals comprising a first set of optical signals in a first wavelength band and at least one additional set of optical signals in at least one additional wavelength band that is different from the first wavelength band, (2) optically splitting the plurality of optical signals into the first set of optical signals and the at least one additional set of optical signals, (3) introducing, after optically splitting the plurality of optical signals, the first set of optical signals onto a first terrestrial optical fiber, and (4) introducing, after optically splitting the plurality of optical signals, the at least one additional set of optical signals onto at least one additional terrestrial optical fiber that is different from the first terrestrial optical fiber.

Also for a cable landing site for a subsea optical fiber, some embodiments of the instant disclosure may include (1) receiving a first set of optical signals carried over a first terrestrial optical fiber in a first wavelength band, (2) receiving at least one additional set of optical signals carried over at least one additional terrestrial optical fiber in at least one additional wavelength band that is different from the first wavelength band, (3) optically combining the first set of optical signals and the at least one additional set of optical signals to form a plurality of optical signals, and (4) introducing, after optically combining the first set of optical signals and the at least one additional set of optical signals, the plurality of optical signals onto the subsea optical fiber.

By splitting the optical signals received from a subsea optical fiber into separate wavelength bands at a cable landing site and introducing the signals of the separate bands onto different terrestrial optical fibers, the disclosed systems and methods may greatly reduce the probability of a single terrestrial fiber cut causing a failure of all signals carried on the subsea optical fiber. Further, by splitting the signals in such a manner, the disclosed systems and methods may maintain the signals in the optical domain, thus possibly avoiding inefficiencies often associated with converting the signals between the optical and electrical domains.

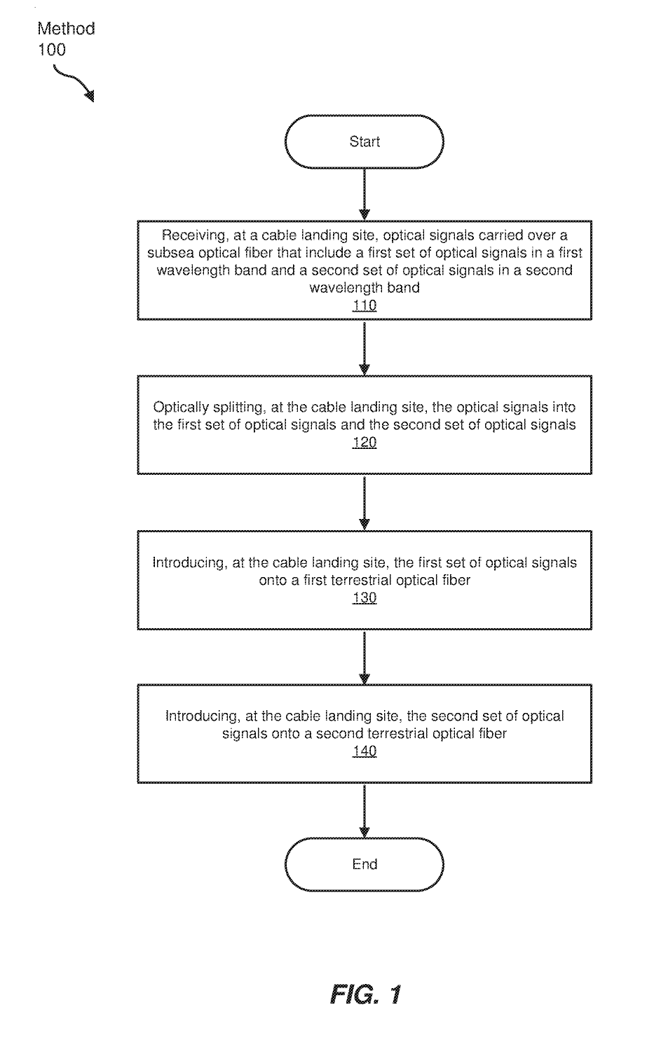

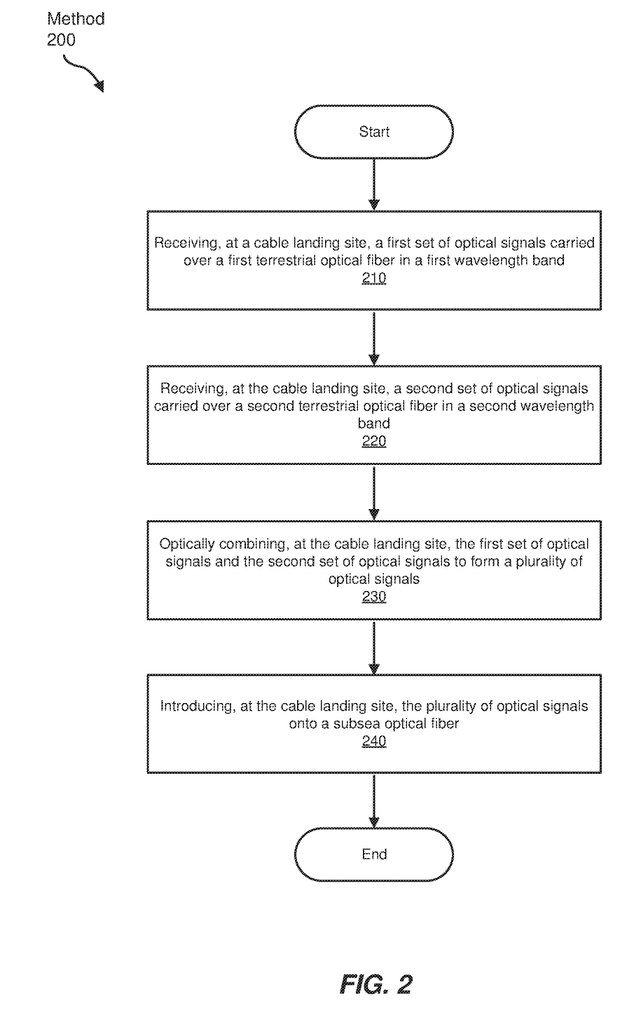

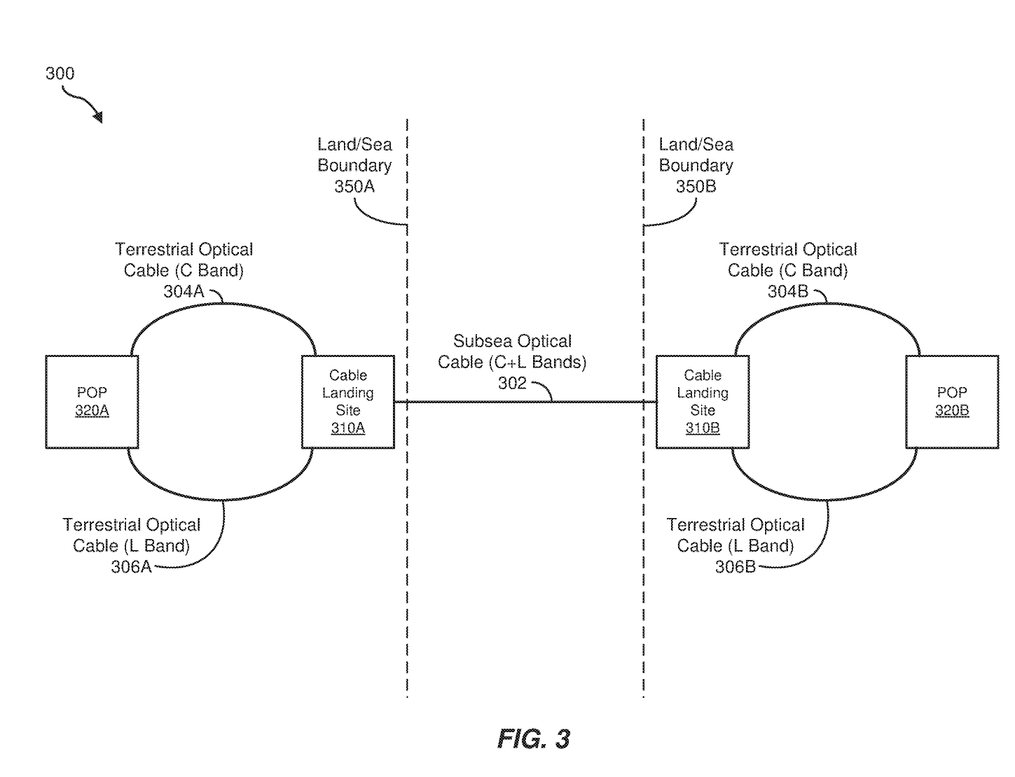

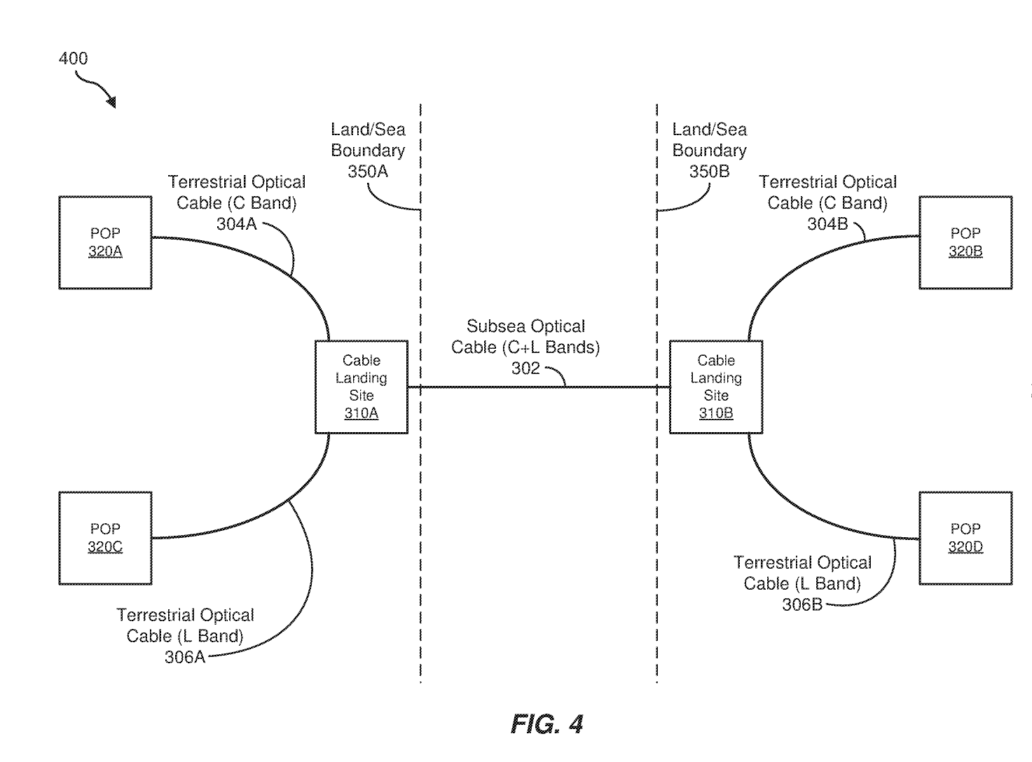

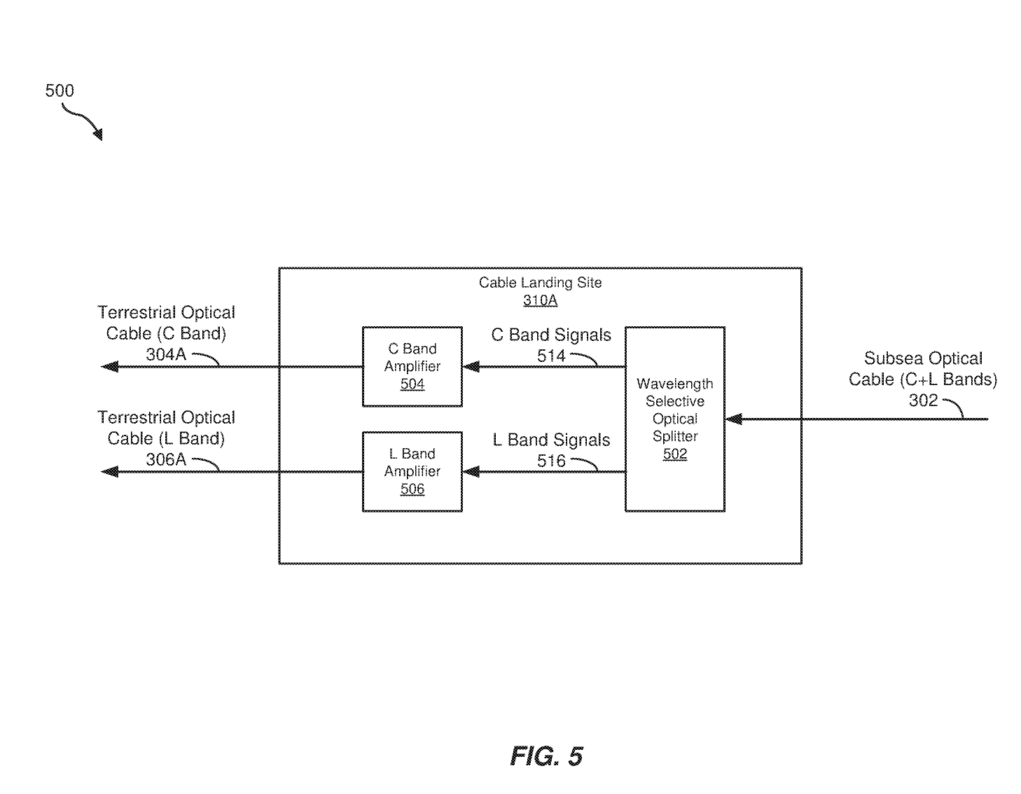

The following will provide, with reference to FIGS. 1 and 2, example split backhaul methods for subsea optical communication links. Detailed descriptions of example split backhaul systems for subsea communication links will be presented in conjunction with FIGS. 3 and 4. In addition, example cable landing sites employable in the example split backhaul systems of FIGS. 3 and 4 are discussed in connection with FIGS. 5-8.

FIGS. 1 and 2 are flow diagrams of example split backhaul methods 100 and 200 for subsea optical communication links. In some examples, the steps shown in FIGS. 1 and 2 may be performed by optical components employable for the transmission of optical communication signals, such as in the backhaul systems of FIGS. 3 and 4. In one example, each of the steps shown in FIGS. 1 and 2 may represent methods with a structure that includes and/or is represented by multiple sub-steps, examples of which will be provided in greater detail below

As illustrated in FIG. 1, at step 110, one or more of the systems described herein may receive, at a cable landing site, optical signals carried over a subsea optical fiber that include a first set of optical signals in a first wavelength band and a second set of optical signals in a second wavelength band. As generally used herein, a cable landing site may be a location at or near where the subsea optical fiber makes landfall. The cable landing site may include a cable termination station at which the subsea optical fiber couples with a terrestrial (e.g., land-based) communication network or infrastructure, such as a backhaul system. Also in example embodiments, the cable landing site may include a cable landing station that may provide power for one or more subsea optical repeaters or amplifiers to facilitate propagation of optical signals over long distances. In some examples, the subsea optical fiber may be one of several subsea optical fibers that constitute at least a part of a subsea optical cable that may be laid in a marine environment (e.g., bay, sea, ocean, or the like) as an integrated unit. As described below, the first wavelength band may be the optical C band and the second wavelength band may be the optical L band, although other optical bands, including optical bands not specifically aligning with currently defined standard optical bands (e.g., the optical C band and the optical L band), may be employed in other example embodiments.

At step 120, the plurality of optical signals may be optically split at the cable landing site into the first set of optical signals and the second set of optical signals. In one example, a band-wise wavelength-selective optical splitter may be employed to split the optical signals received at an end of the subsea optical fiber into a first optical beam carrying the first set of optical signals and a second optical beam carrying the second set of optical signals. In some embodiments, the optical splitter may be directly coupled to the subsea optical fiber to receive the plurality of optical signals.

Thereafter, at step 130, the first set of optical signals may be introduced onto a first terrestrial optical fiber, and at step 140, the second set of optical signals may be introduced onto a second terrestrial optical fiber different from the first terrestrial optical fiber. In some examples, an end of the first terrestrial optical fiber and an end of the second terrestrial optical fiber may be coupled directly to the optical splitter.

While a single subsea optical fiber is referenced above in relation to method 100 of FIG. 1, multiple such optical fibers, each carrying a separately plurality of optical signals, may be present in a single subsea optical cable. Consequently, each subsea optical fiber may be coupled with a corresponding optical splitter to split the optical signals of that fiber into a first set of optical signals in the first wavelength band and a second set of optical signals in the second wavelength band. Moreover, each subsea optical fiber and associated optical splitter may be coupled with corresponding first and second terrestrial fibers onto which the first and second sets of optical signals for that subsea optical fiber are introduced.

FIG. 2 is a flow diagram of an example split backhaul method 200 for subsea optical communication links. Whereas method 100 of FIG. 1 involves optical signals received over a subsea optical fiber and introduced onto two separate terrestrial optical fibers, method 200 involves optical signals received over two separate terrestrial optical fibers and introduced onto a subsea optical fiber. At step 210, a first set of optical signals carried over a first terrestrial optical fiber in a first wavelength band may be received at a cable landing site. At step 220, a second set of optical signals carried over a second terrestrial optical fiber in a second wavelength band may be received at the cable landing site. As indicated above in conjunction with method 100, the first wavelength band may be the optical C band and the second wavelength band may be the optical L band, although other optical bands may be utilized in other examples.

At step 230, the first set of optical signals received from the first terrestrial optical fiber and the second set of optical signals received from the second terrestrial optical fiber may be optically combined at the cable landing site to form a plurality of optical signals. At step 240, the plurality of optical signals may then be introduced onto a subsea optical fiber. In some examples, an optical combiner may combine the optical beams carrying the first and second set of optical signals from the terrestrial optical fibers and combine them into a single optical beam that is introduced onto the subsea optical fiber. In some embodiments, the optical combiner may be directly coupled to the subsea optical fiber to introduce the plurality of optical signals.

While a single subsea optical fiber is referenced above in relation to method 200 of FIG. 2, multiple such optical fibers, each carrying a separately plurality of optical signals, may be present in a single subsea optical cable. Consequently, each subsea optical fiber may be coupled with a corresponding optical combiner that combines the first and second set of optical signals of associated first and second terrestrial fibers for introduction onto that subsea optical fiber. Moreover, each subsea optical fiber and associated optical combiner may be coupled with corresponding first and second terrestrial optical fibers that provide the first and second sets of optical signals.

As is described in greater detail below in conjunction with FIGS. 5-8, one or more optical amplifiers may be employed in conjunction with method 100 and/or method 200 to facilitate amplification of the optical signals that have or will be carried over long distances, either in the subsea or terrestrial optical fibers.

In some examples, a cable landing site may operate according to both method 100 and method 200. For example, one subsea optical fiber may be used for method 100, while a separate subsea optical fiber may be used for method 200, such that each subsea optical fiber carries optical signals in a single direction. Also in some examples, separate first terrestrial optical fibers and separate second terrestrial optical fibers may be used to carry associated sets of optical signals unidirectionally. In other embodiments, a single subsea optical fiber may be employed in both method 100 and method 200, thereby operating bidirectionally by carrying two different pluralities of optical signals, one in each direction along the subsea optical fiber. Similarly, a single first terrestrial optical fiber and/or a single second terrestrial optical fiber each may be employed to carry sets of optical signals in a bidirectional manner. In other examples, separate first and/or second terrestrial optical fibers may be employed for method 100 and method 200, with each terrestrial optical fiber carrying a set of optical signals in a single direction.

While method 100 and method 200 each involves a first wavelength band and a second wavelength band, along with corresponding first and second terrestrial optical fibers, three or more wavelength bands, with corresponding numbers of terrestrial optical fibers, may be employed in other examples with a single subsea optical fiber. For example, the optical signals of a subsea optical fiber may be optically split into sets of optical signals in first, second, and third separate wavelength bands, with each set being carried over a separate terrestrial optical fiber. Sets of optical signals in four or more wavelength bands may be optically split and carried in a corresponding manner. Similarly, the combining and carrying of sets of the optical signals in three or more separate wavelength bands may be performed in an associated fashion.

FIGS. 3 and 4 are block diagrams of subsea optical communication links provided by a subsea optical cable 302 with associated cable landing sites 310A and 310B (collective, cable landing sites 310) at opposing ends of subsea optical cable 302, approximately located at corresponding land/sea boundaries 350A and 350B. Other components, such as optical amplifiers or repeaters, may be included with subsea optical cable 302, but such components are not illustrated in FIGS. 3 and 4 to simplify the following discussion. As indicated in FIGS. 3 and 4, the first and second wavelength bands are the C optical band and the L optical band. However, optical signals of other optical wavelength bands may be utilized in other embodiments.

In examples depicted in FIG. 3, cable landing site 310A is coupled to a single point of presence (POP) 320A with two separate terrestrial optical cables: a first terrestrial optical cable 304A carrying a first set of optical signals in the C band, and a second terrestrial optical cable 306A carrying a second set of optical signals in the L band. Similarly, at the opposing end of the subsea optical cable 302, cable landing site 310E is coupled to a single POP 320B with two separate terrestrial optical cables: a third terrestrial optical cable 304B carrying the first set of optical signals in the C band, and a fourth terrestrial optical cable 306B carrying the second set of optical signals in the L band. In some embodiments, terrestrial optical cables 304A, 306A, 304B, and 306B (alternatively, terrestrial optical cables 304 and 306), along with cable landing sites 310A and 310B, constitute at least a part of a backhaul system for the subsea optical cable 302. Generally, a POP may be a communication network demarcation point or interface point, such as between the backhaul systems for the subsea optical cable 302 and a service provider (e.g., Internet service provider (ISP)). In some examples, a POP may include one or more servers, routers, network switches, multiplexers, and/or other network interface equipment.

In examples illustrated in FIG. 4, first terrestrial optical cable 304A may carry the first set of optical signals (e.g., C band optical signals) between cable landing site 310A and a first POP 320A while second terrestrial optical cable 306A may carry the second set of optical signals (e.g., L band optical signals) between cable landing site 310A and a second POP 320C. In a corresponding manner, terrestrial optical cable 304B may carry the first set of optical signals (e.g., C band optical signals) between cable landing site 310E and a third POP 320B while terrestrial optical cable 306A may carry the second set of optical signals (e.g., L band optical signals) between cable landing site 310B and a fourth POP 320D.

As illustrated in both FIGS. 3 and 4, terrestrial optical cables 304A and 306A may be routed along different paths in some examples. Similarly, terrestrial optical cables 304B and 306B may be routed along different paths in some embodiments. Such paths may help prevent both terrestrial optical cable 304A and terrestrial optical cable 306A, or both terrestrial optical cable 304B and terrestrial optical cable 306B, from being cut or otherwise negatively impacted by the same event or failure. In the examples of FIG. 3, in which a single POP 320A is coupled to cable landing site 310A and a single POP 320B is coupled to cable landing site 310B, the use of different paths may help prevent all fiber capacity from being eliminated due to a single point of failure along a particular path between cable landing site 310A and POP 320A. For example, if POP 320A or POP 320B is employed by a single ISP, less than all of the communication capacity the ISP provides to its customers via subsea optical cable 302 may be disrupted by a cut of a single terrestrial cable.

As to FIG. 4, in which two POPs 320A and 320C are coupled to cable landing site 310A and two POPs 320B and 320D are coupled to cable landing site 310B, each ISP involved may manage only those optical channels carried in a single optical band (e.g., the C band or the L band). For example, POP 320A may be operated by one ISP, which may only manage channels in the C band, while POP 320C may be operated by another ISP, which may only manage channels in the L band. Apportioning the optical signals in the two bands among the two ISPs may thus facilitate simplified channel management. Additionally, separating the channels according to optical band between POPs 320A and 320C, and similarly between POPs 320B and 320D, may simplify any optical amplifiers, couplers, splitters, combiners, multiplexers, or de-multiplexers used at POPs 320 since only a single band is employed at any particular POP 320.

In some examples of both FIGS. 3 and 4, the paths taken by terrestrial optical cables 304A and 306A, as well as the paths taken by terrestrial cables 304B and 306B, may not exhibit any commonality other than possibly one or both terminating ends. For example, terrestrial optical cables 304A and 306A may exit cable landing site 310A in substantially opposing directions. Terrestrial optical cables 304E and 306B may exit cable landing site 310E in a similar manner in some embodiments. Similarly, with respect to FIG. 3, terrestrial optical cables 304A and 306A may exit POP 320A in substantially opposing directions, and terrestrial optical cables 304B and 306B may exit POP 320B in a corresponding fashion.

In some embodiments, each of terrestrial optical cables 304 and 306 and subsea optical cable 302, as depicted in FIGS. 3 and 4, may carry one or more optical fibers. In some examples, each of terrestrial optical cables 304 and 306 may carry the same number of fibers as subsea optical cable 302. Also in some examples, one or more of optical fibers 302, 304, and 306 may carry optical signals unidirectionally or bidirectionally, as indicated above.

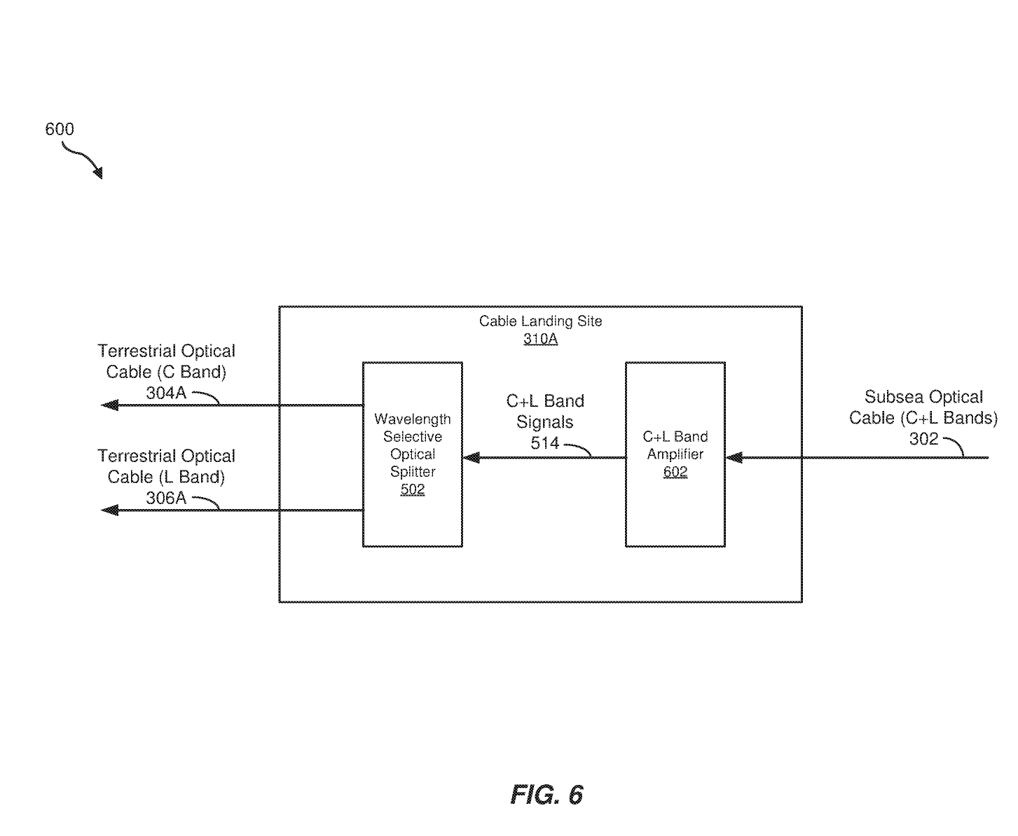

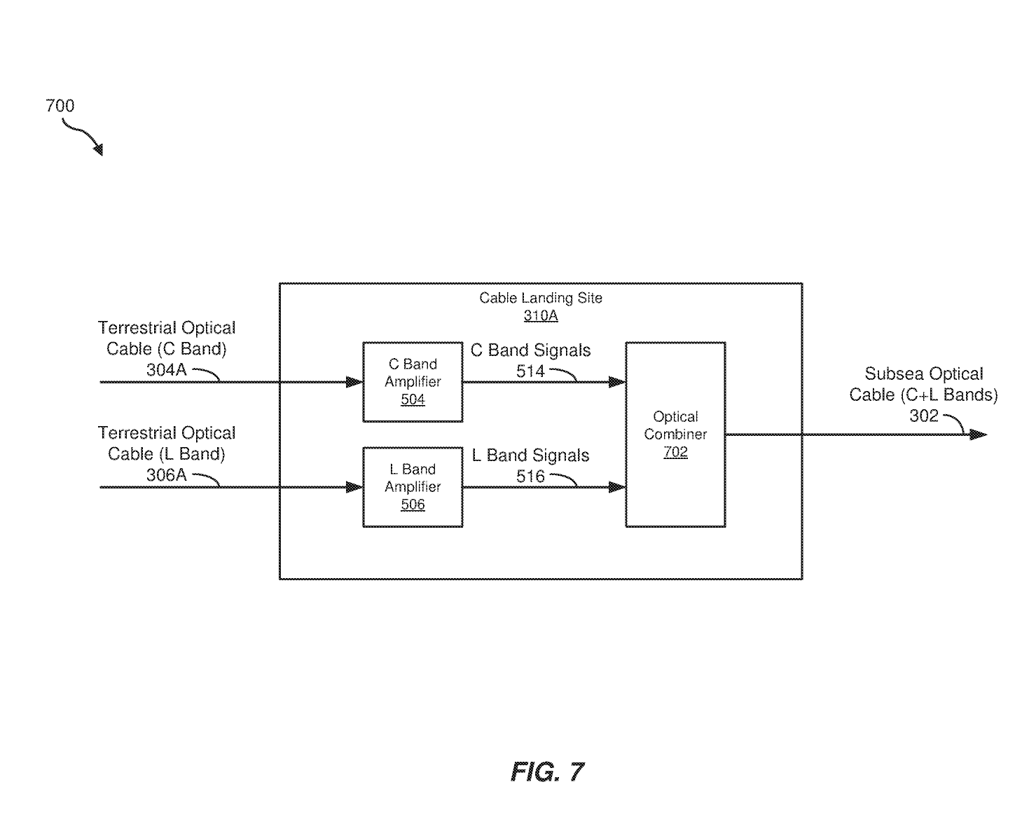

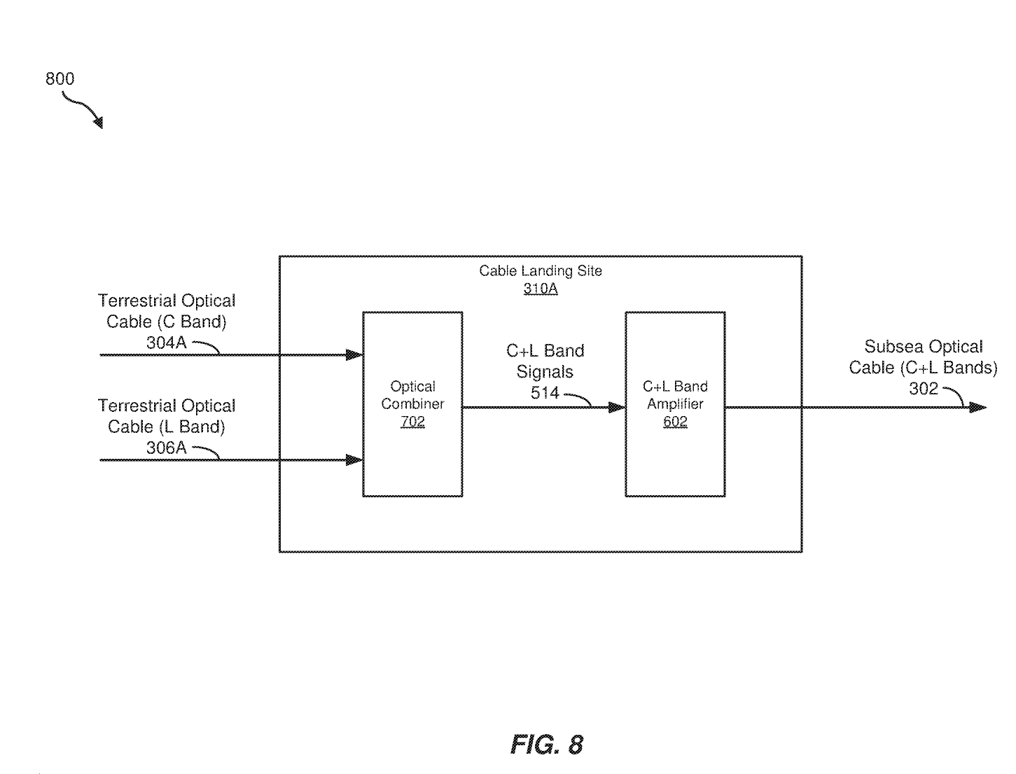

FIGS. 5-8 are block diagrams of examples of cable landing site 310A of FIGS. 3 and 4. In some embodiments, cable landing site 310B may be configured in a corresponding manner as cable landing site 310A. FIGS. 5 and 6 depict examples of cable landing site 310A in which optical signals are received from subsea optical cable 302 (e.g., as discussed above in conjunction with method 100 of FIG. 1), while FIGS. 7 and 8 illustrate examples of cable landing site 310A in which optical signals are introduced onto subsea optical cable 302 (e.g., as indicated earlier with respect to method 200 of FIG. 2).

In cable landing site 310A of FIG. 5, a wavelength selective optical splitter 502 may split a plurality of optical signals in the combined C and L bands carried over an optical fiber of subsea optical cable 302 into a set of C band signals 514 and a set of L band signals 516. A C band amplifier 504 may then amplify C band signals 516 prior to introducing the signals onto an optical fiber of terrestrial optical cable 304A, and an L band amplifier 506 may amplifier L band signals 516 prior to introducing them onto an optical fiber of terrestrial optical cable 306A. In some examples, using separate amplifiers 504 and 506 for C band signals 514 and L band signals 516, respectively, may allow each of amplifiers 504 and 506 to be relatively simple in design and implementation while providing separate points of failure for the amplification portion of cable landing site 310A.

In cable landing site 310A of FIG. 6, a single C+L band amplifier 602 may amplify the plurality of optical signals carried over an optical fiber of subsea optical cable 302. Wavelength selective optical splitter 502 may then receive amplified C+L Band signals 514 from C+L band amplifier 602 and split them into their corresponding C band optical signals and L band optical signals prior to introducing them onto associated optical fibers of terrestrial optical cable 304A and 306C, respectively. In some embodiments, use of single C+L band amplifier 602 may reduce the number of amplifiers used in cable landing site 310A. In yet other examples, no optical amplifiers may be employed in cable landing site 310A prior to introducing optical signals onto terrestrial optical cables 304A and 306A.

In FIG. 7, C band amplifier 504 may amplify optical signals received from an optical fiber of terrestrial optical cable 304A, and L band amplifier 506 may amplify optical signals received from an optical fiber of terrestrial optical cable 306A. Optical combiner 702 may combine C band signals 514 from C band amplifier 504 and L band signals 516 from L band amplifier 506 to produce the plurality of optical signals in the C and L bands for introduction onto an optical fiber of subsea optical cable 302. Similar to the examples of FIG. 5, the use of separate amplifiers 504 and 506 in FIG. 7 may be simplify the design of each amplifier 504 and 506 as well as provide separate failure points in the amplification portions of cable landing site 310A.

In FIG. 8, optical combiner 702 may first combine the sets of optical signals in the separate C and L bands from an optical fiber of each of terrestrial optical cables 304A and 306A. C+L band amplifier 602 may then amplify combined C+L band signals 514 from optical combiner 702 and introduce the amplified plurality of optical signals onto an optical fiber of subsea optical cable 302. Similar to the examples of FIG. 6, the use of single C+L band amplifier 602 may reduce the overall number of amplifiers employed at cable landing site 310A. In yet other embodiments, no optical amplifiers may be employed in cable landing site 310A prior to introducing optical signals onto subsea optical cable 302.

In some examples of FIGS. 5-8, each of terrestrial optical cables 304A and 306A and subsea optical cable 302 may include multiple optical fibers. In such examples, each optical fiber of each cable 304A, 306A, and 302 may be associated with a separate corresponding splitter 502, combiner 702, and/or amplifier 504, 506, and 602. In yet other embodiments, a single splitter 502, combiner 702, and/or amplifier 504, 506, and 602 may operate with multiple optical fibers simultaneously.

Also, in subsea optical communication links that carry optical communication signals in both directions, various combinations of FIGS. 5-8 may be employed in cable landing site 310A, as well as in corresponding cable landing site 310B.

As explained above in conjunction with FIGS. 1-8, the split backhaul systems and methods for subsea optical communication links, as described herein, may facilitate the use of simplified optical distribution and/or amplification systems at one or more cable landing sites, thus reducing or eliminating the use of optical-electrical domain conversion at those sites. Further, POP design may be simplified by receiving, amplifying, and/or converting only optical signals of a particular optical band (e.g., the C band or the L band) on any particular optical fiber or cable. Further, optical channel management (e.g., assignment of data channels to active or spare optical channels) at a POP for a particular optical fiber or cable may be simplified since only a single optical band is involved. In addition, the use of different paths for the separate terrestrial optical cables coupling a cable landing site to one or more associated POPs may help prevent a single failure, such as a fiber failure or cable cut, from affecting all of the available communication capacity provided at the cable landing site.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the instant disclosure. The embodiments disclosed herein should be considered in all respects illustrative and not restrictive. Reference should be made to the appended claims and their equivalents in determining the scope of the instant disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A method comprising:
receiving, at a cable landing site for a subsea optical fiber, a plurality of optical signals carried over the subsea optical fiber, the plurality of optical signals comprising a first set of optical signals in a first wavelength band and at least one additional set of optical signals in at least one additional wavelength band that is different from the first wavelength band;
optically splitting, at the cable landing site, the plurality of optical signals into the first set of optical signals and the at least one additional set of optical signals;
introducing, at the cable landing site after optically splitting the plurality of optical signals, the first set of optical signals onto a first terrestrial optical fiber; and
introducing, at the cable landing site after optically splitting the plurality of optical signals, the at least one additional set of optical signals onto at least one additional terrestrial optical fiber that is different from the first terrestrial optical fiber.

2. The method of claim 1, wherein the first wavelength band comprises a C optical wavelength band, and the at least one additional wavelength band comprises an L optical wavelength band.

3. The method of claim 1, further comprising optically amplifying the plurality of optical signals before optically splitting the plurality of optical signals.

4. The method of claim 1, further comprising:
optically amplifying the first set of optical signals after optically splitting the plurality of optical signals; and
optically amplifying the at least one additional set of optical signals after optically splitting the plurality of optical signals.

5. The method of claim 1, further comprising:
carrying, by the first terrestrial optical fiber, the first set of optical signals from the cable landing site to a network point of presence; and
carrying, by the at least one additional terrestrial optical fiber, the at least one additional set of optical signals from the cable landing site to the network point of presence.

6. The method of claim 5, wherein the first terrestrial optical fiber follows a first path and the at least one additional terrestrial optical fiber follows at least one additional path that is different from the first path.

7. The method of claim 1, further comprising:
carrying, by the first terrestrial optical fiber, the first set of optical signals from the cable landing site to a first network point of presence; and
carrying, by the at least one additional terrestrial optical fiber, the at least one additional set of optical signals from the cable landing site to at least one network point of presence different from the first network point of presence.

8. A method comprising:
receiving, at a cable landing site for a subsea optical fiber, a first set of optical signals carried over a first terrestrial optical fiber in a first wavelength band;
receiving, at the cable landing site, at least one set of optical signals carried over at least one additional terrestrial optical fiber in at least one additional wavelength band that is different from the first wavelength band;
optically combining, at the cable landing site, the first set of optical signals and the at least one additional set of optical signals to form a plurality of optical signals; and
introducing, at the cable landing site after optically combining the first set of optical signals and the at least one additional set of optical signals, the plurality of optical signals onto the subsea optical fiber.

9. The method of claim 8, wherein the first wavelength band comprises a C optical wavelength band, and the at least one additional wavelength band comprises an L optical wavelength band.

10. The method of claim 8, further comprising optically amplifying the plurality of optical signals after optically combining the first set of optical signals and the at least one additional set of optical signals.

11. The method of claim 8, further comprising:
optically amplifying the first set of optical signals before optically combining the first set of optical signals and the at least one additional set of optical signals; and
optically amplifying the at least one additional set of optical signals before optically combining the first set of optical signals and the at least one additional set of optical signals.

12. The method of claim 8, further comprising:
carrying, by the first terrestrial optical fiber, the first set of optical signals from a network point of presence to the cable landing site; and
carrying, by the at least one additional terrestrial optical fiber, the at least one additional set of optical signals from the network point of presence to the cable landing site.

13. The method of claim 12, wherein the first terrestrial optical fiber follows a first path and the at least one additional terrestrial optical fiber follows at least one additional path that is different from the first path.

14. The method of claim 8, further comprising:
carrying, by the first terrestrial optical fiber, the first set of optical signals from a first network point of presence to the cable landing site; and
carrying, by the at least one additional terrestrial optical fiber, the at least one additional set of optical signals from at least one additional network point of presence that is different from the first network point of presence to the cable landing site.

15. A system comprising:
an optical signal splitter, located at a cable landing site, that optically splits a first plurality of optical signals received from a first subsea optical fiber into a first set of optical signals in a first wavelength band for introduction onto a first terrestrial optical fiber, and a second set of optical signals in a second wavelength band different from the first wavelength band for introduction onto a second terrestrial optical fiber different from the first terrestrial optical fiber; and
an optical signal combiner, located at the cable landing site, that optically combines a third set of optical signals in the first wavelength band received from a third terrestrial optical fiber and a fourth set of optical signals in the second wavelength band received from a fourth terrestrial optical fiber to form a second plurality of optical signals for introduction onto a second subsea optical fiber.

16. The system of claim 15, wherein the second subsea optical fiber is the first subsea optical fiber.

17. The system of claim 15, wherein the third terrestrial optical fiber is the first terrestrial optical fiber.

18. The system of claim 15, wherein the fourth terrestrial optical fiber is the second terrestrial optical fiber.

19. The system of claim 15, wherein:
the first terrestrial optical fiber and the third terrestrial optical fiber couple the cable landing site to a network point of presence along a first path; and
the second terrestrial optical fiber and the fourth terrestrial optical fiber couple the cable landing site to the network point of presence along a second path different from the first path.

20. The system of claim 15, wherein:
the first terrestrial optical fiber and the third terrestrial optical fiber couple the cable landing site to a first network point of presence along a first path; and
the second terrestrial optical fiber and the fourth terrestrial optical fiber couple the cable landing site to a second network point of presence different from the first network point of presence along a second path different from the first path.
